(19) United States
(12) Patent Application Publication
(10) Pub. No.: US 2013/0054289 A1
(43) Pub. Date: Feb. 28, 2013

(54) System and Method for Budget-Compliant, Fair and Efficient Manpower Management

(71) Applicants: Siddhartha SenGupta, Mumbai (IN); Shripad Salsingikar, Mumbai (IN); Soumen Bose, Mumbai (IN); Viswanath Ganesan, Mumbai (IN)

(72) Inventors: Siddhartha SenGupta, Mumbai (IN); Shripad Salsingikar, Mumbai (IN); Soumen Bose, Mumbai (IN); Viswanath Ganesan, Mumbai (IN)

(73) Assignee: TATA CONSULTANCY SERVICES LIMITED, Maharashtra (IN)

(21) Appl. No.: 13/395,982

(22) PCT Filed: Nov. 16, 2010
(86) PCT No.: PCT/IN10/00749

§ 371 Date: Apr. 10, 2012

(30) Foreign Application Priority Data
Nov. 16, 2009 (IN) 2639/MUM/2009

(51) Int. Cl. G06Q 10/10

(52) U.S. Cl. 705/7.13

(57) ABSTRACT

The present invention relates to a method and system for budget-compliant, fair and efficient manpower management primarily for service industries to improve customer service, save costs, improve employee morale and productivity. More particularly the present invention relates to a system and method enabling labour planners and schedulers to rapidly develop a budget-compliant, fair, effective, easy to use and manageable and deployable manpower schedule to optimize and increase effective manpower productivity. Further the system and method of the present invention generates manpower plans and schedules suitable for deployment, on the basis of two novel criteria's a) compliance of allocations to planned labour budgets while also being driven by business forecasts and b) using several fairness” criteria so that the desirable and undesirable features of the schedules are equitably dispersed. Further, the invention provides a system which can be deployed with several optional hardware and network architecture and configuration.

### FIELD OF THE INVENTION

The present invention relates to a method and system for a budget-compliant, fair and efficient manpower management primarily for service industries that improves customer service, saves costs and improves employee morale and productivity. More particularly the present invention relates to a system and method which enables manpower planners and schedulers to rapidly develop a budget-compliant, fair, effective, easy to use, manageable and deployable manpower schedule to optimize and increase effective manpower productivity.

Further the system and method of the present invention generates manpower plans and schedules that are most suitable for deployment, by basing on two novel criteria a) compliance of scheduled allocations to planned manpower budgets while also being driven by business forecasts and b) using several “fairness” criteria so that the desirable and undesirable features of the schedules are equitably dispersed. The system and method of the present invention provides a scalable and time efficient manpower management in several optional hardware and network architecture and configuration.

### BACKGROUND OF THE INVENTION AND PRIOR ART

Manpower planning and scheduling is an important and complex task across both manufacturing and service (retail stores, hotels, restaurants, call centres, banking, academics, trading, and information technology, etc.) industry sectors.

Other than in the most trivial situations, manpower scheduling is a non deterministic polynomial time—complete problem (NP-Complete problem) as there is no known method that can be used to generate manpower schedules within polynomial time limits.

The complexity for manpower planning and scheduling is further impacted by the following parameters:
Variable Shift length and start time and granularity of time period
Work force—size, heterogeneity and multi-skilling
Continuous (24 hours) and discontinuous (non 24 hours) operations of the business units
Work rules (corporate, statutory and union)

In recent times many approaches have been put forth for manpower planning, scheduling and managing with the help of rapidly advancing technologies; wherein the manpower planning and scheduling systems and methods of the current state of art invariably consist of the following four distinct steps:
Demand forecasting generally based on business history
Workload generation: wherein the demand forecasts are translated into staffing needs
Scheduling the manpower, minimizing costs and under/overstaffing to the extent possible under various types of constraints
Controlling the schedule implementation in the face of unexpected situations

These 4 steps have two essential lacunae that lead to the automatically generated schedules to be repeatedly regenerated together with negotiations between the persons doing the scheduling and their managers or the manpower managers who, plan the business and allocate budgets. These two extremely critical drawbacks of manpower schedules currently generated automatically are:
1. Manpower allocation and scheduling is invariably constrained by budgetary allocations determined by higher levels of management planning. The four steps described above completely ignore the budget and proceed with the forecasted demand alone. Any schedule or allocation plan that violates the budget will have perforce to be modified with considerable effort to ensure that the expenses incurred will be actually approved. Budgets may, for instance, be distributed across departments of a retail store to justify some larger merchandizing strategy changes. But as historical business would reflect only the past demand forecasts (normally based on historical data) would not be naturally aligned to these strategies. Special effort is needed to ensure the overriding influence of the plan embodied in the strategic budgets over the operational schedules.
2. The concept of fairness is not used in modern automated scheduling systems. The automated schedulers use mathematics or meta-heuristics or heuristics to minimize total costs and under/over-staffing. These approaches do not discriminate between where, when or at whose expense the undesirable costs and unbalanced demand-supply occur. As a matter of fact major portions of these negative aspects may be localized leading to mathematically good-looking but practically unattractive schedules. Such localization may, for example, even lead to such extreme situations where all the allocation shortfalls are in the same day or for one type of work.

Hence there is an urgent need for a method and system for a budget-compliant, fair and efficient and effective manpower management to optimize and increase the efficacy of both the process and the output of manpower planning and scheduling by ensuring that alignment to the budget and the several critical dimensions of fairness are enshrined in the design objectives and delivered in normal course and not by exception or chance. The present invention is designed and implemented to provide such pragmatic solutions.

Some of the inventions which deal with providing manpower management are listed below. None address the two lacunae stated above.
U.S. Pat. No. 5,185,780 titled “Method for predicting agent requirements in a force management system” provides a method for predicting the number of agents required and then uses these values in successive Erlang C calculations to locate the desired number of agents required to provide a given service level.
U.S. Pat. No. 7,672,746 titled “Systems and methods for automatic scheduling of a workforce” focuses only on scheduling overtime and time-off for a workforce.
U.S. Pat. No. 7,058,589 titled “Method and system for employee work scheduling” provides a method to correct schedule for workers prioritized choices. It does not cover core elements of fairness criterion.
PCT patent application 2007090410 titled “A Method and System for Resource Planning” names historical ratios as fairness parameters providing ‘fairness to history’ but not to the ‘work in hand’. The fairness parameters are static, not dynamic, ratios based on history.

In order to address the need of such a solution the present invention provides a system and method for budget-compliant, fair, highly scalable and time efficient manpower management for optimizing and increasing the efficacy of manpower planning and scheduling.

### OBJECTS OF THE INVENTION

The object of the invention is to provide a system and method for effective manpower management.

Another object of the invention is to enable the development of manpower schedules to optimize customer service, manpower costs and employee morale and thus increase the value of the schedules.

Yet another object of the invention is to enable the development of manpower schedules that meet a user-defined set of statutory, corporate or union rules or constraints thereby ensuring that the schedules are legally and otherwise fit for implementation i.e. schedules are compliant to regulation and policy.

A principal object of the invention is to enable the development of manpower schedules whose costs and their distributions are compliant to the budgetary manpower expense plans while being driven by requirement forecasts from historical business, subject to various related constraints.

Yet another object of the invention is to provide a system and method for optimally positioning fixed (often called home office) workload to minimize manpower requirements.

Yet another principal object of the invention is to provide a system and method for generating manpower plans and schedules that meet a set of “fairness” criteria including, but not limited to, fairness across employees, types of jobs, hours of each days or days of week.

Another object of the invention is to provide a system and a method for the easy and effective manual modifications and changes to the schedules to improve their implementability and value.

### SUMMARY OF THE INVENTION

The present invention discloses a system and method for effective manpower management.

The present invention implements a method for a budget-compliant, fair and efficient manpower management for primarily service industries that balances customer service, costs and employee morale, wherein the said method comprises the computer implemented steps of:
a) Configuring the parameters, optional or mandatory, including but not limited to, the relative importance of the different scheduling goals, planning interval time granularities and the scheduling engine parameters; downloading these parameters from relevant corporate systems or data bases; and downloading the description of the unit where manpower is being managed which includes location, size, hours of operations (24 hours, non 24 hours), jobs to be performed, engineering work standards applicable and the description as well as constraints on the available workforce from relevant corporate human resources data bases;
b) Extracting, Transforming and Loading the business history from corporate databases and using them for forecasting business drivers and indicators using one or more provisions;
c) Converting the forecasted business drivers of step (b) into manpower hours of different skill types;
d) Bringing consistency and fairness of the manpower budget allocations and the costs of the forecasted manpower hours of step (c) by, but not limited to, ensuring similar proportions or by adjustments of either of the two by using a mutual negotiation mechanism, both the steps subjected to specific constraints;
e) Distributing or positioning the fixed work hours optimally to the respective jobs, roles or time of day or week thereby reducing the manpower hours;
f) Allocating the available manpower to optimally match the budget and forecast-balanced manpower requirements hours while minimizing costs and under/overstaffing and maximizing the fairness of the allocation in at least three dimensions to the extent possible under various types of constraints for subsequently generating a manpower plan and schedule;
g) Enabling the viewing and optional modification or adjustment of the generated manpower plan and schedule of step (f) through an interactive Gantt chart and automatic reallocation of the breaks post modification;
h) Monitoring the real time deviations of schedules during day-to day operations through a real time alert generation mechanism and enabling the modification or adjustment of the manpower allocation to meet the day of operations exigencies based on the output of the steps (g) and/or (h);
i) Updating the planned allocations into the corporate data bases including, but not limited to, that for Time and Attendance.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings, example constructions of the invention; however, the invention is not limited to the specific methods disclosed in the drawings:

FIG. 1 of the present invention illustrates optional (centralized) system architecture for manpower planning and scheduling system; wherein other valid architectures are also described by an embodiment.

FIG. 2 of the present invention illustrates the subsystems and information flows and transforms involved in manpower planning and scheduling.

FIG. 3 of the present invention illustrates the system inputs and outputs for manpower planning and scheduling system.

FIG. 4 of the present invention illustrates one optional sub-system and mechanism to ensure budgetary compliance for manpower costs incurred in the schedule.

FIG. 5 of the present invention illustrates the sub-system and process/steps of generating and modifying schedule i.e. it represents a schematic diagram of the schedule generator.

FIG. 6 of the present invention illustrates the system and method of calculating the objective function value for a schedule. It illustrates the fairness calculation mechanism and other costs used for manpower planning and scheduling by an embodiment.

### DETAILED DESCRIPTION OF THE INVENTION

Before the present method computing, hardware and communication enablement are described, it is to be understood that this invention in not limited to the particular methodologies, and hardware and network described, as these may vary within the specification indicated. It is also to be understood that the terminology used in the description is for the purpose of describing the particular versions or embodiments only and is not intended to limit the scope of the present invention which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. The disclosed embodiments are merely exemplary methods of the invention which may be embodied in various forms. The words “work force”, manpower, labour, staff, employee, associate and other forms are used as synonyms in the present invention. The words “schedule”, “plan” “allocation”, and other forms are also used as synonyms in the present invention. While the invention is of special value in many service organizations, many manufacturing and other organizations share the complexities of manpower scheduling described above and the invention is valuable and applicable to all such organizations too. The words “hours of day” or “days of week” are intended to be exemplars of various periods of time applicable to the industry and organization. The words “week” or “plan days” are intended to be exemplars of planning horizon, which may be 7 days or more or even less than 7 days.

One of the significant embodiments of the present invention provides a manpower management system for providing a scalable, time efficient, budget compliant manpower plan and schedule, wherein the said system comprises of:
a. manpower planning and scheduling core application server;
b. one or more databases stored on a computer readable medium;
c. forecasting engine and scheduling engine;
d. one or more external system integrated with the manpower management system through one or more computer network;
e. communication means with a user interface associated with manpower management system;
f. module for building consistency and fairness between the manpower budget allocations and the costs of the manpower hour estimations; wherein the costs and distributed manpower hours are made compliant to the budgetary manpower allocation and expense plans;
g. module for optimally allocating the available manpower and generating fair manpower plans and schedules and allocating breaks for each shift; wherein the said manpower plans and schedules are generated on the basis of one or more “fairness” criterion by considering one or more dimensions.

In another preferred embodiment of the present invention, the manpower management system further comprises of the following computer implemented software modules:
module for downloading and configuring the parameters of the manpower management system and further downloading and integrating static and dynamic organizational data, budget and manpower data on the said ‘Forecasting engine’ and ‘Scheduling engine’ of the said manpower management system from the external system integrated to the manpower management system;
module for extracting, transforming and loading business history and forecasting future business volumes on a database of the manpower management system by the data ware house system using the Extract, Transform and Load processor (ETL processor);
module for converting the forecasted business volumes into manpower hours;
module for distributing or positioning the fixed work optimally;
module for viewing and optionally modifying or adjusting the generated manpower plan and schedule; through highly interactive Gantt chart and reallocating breaks automatically post modification;
module for transferring the planned and scheduled allocations into external data bases including, but not limited to, that for Time and Attendance.
modules being distributed on different networked computing systems in a plurality of possible architectures and configurations.

The present invention provides a method for manpower management; wherein the method enables users to develop budget-compliant, fair and efficient manpower plans and schedules for primarily service industries that also balance customer satisfaction, costs and employee morale.

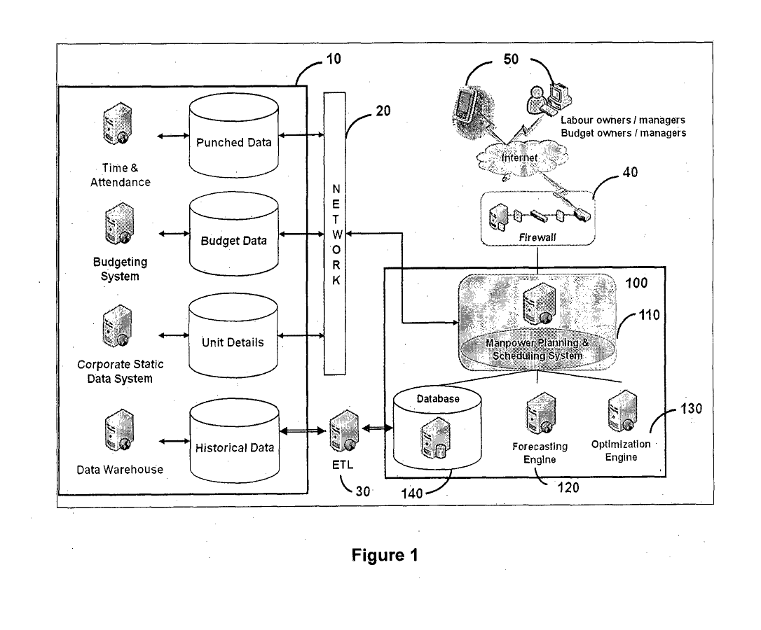

FIG. 1 of the present invention illustrates optional (centralized) system architecture for manpower planning and scheduling system; wherein other valid architectures are also described by an embodiment.

In one of the preferred implementations, the system has a centralized architecture where the majority of the system is installed at corporate location of the organization. The system preferably would have preferably separate servers each for forecasting engine, scheduling engine, database and core application.

In this centralized architecture, the manpower planning and scheduling system (100) would have following major components
‘Application Server’ (110), which hosts the modules and subsystems for user interface (including control flow), integration module to connect with other external systems.
‘Forecasting Engine’ (120) and ‘Scheduling Engine’ (130), which hosts analytical modules/components such as forecasting, workload generator, matching budget and hours, positioning fixed hours and scheduling.
‘Database’ (140); consist of a database which stores entire static/dynamic data required for system and method.

In this centralized architecture, the manpower planning and scheduling system is integrated to various external systems/databases (10) such as a ‘Business history data warehouse’, a ‘Budgeting system’, a ‘Corporate units database system’, a ‘Time and Attendance system’, a ‘Human Resource system’ to fetch the data such as Historical business volumes, Budgets, Business unit details, Attendance data/Actual schedule execution, Workforce details through appropriate communication networks (20).

In this centralized architecture, the user interface for the manpower planning and scheduling system is preferably a web based interface and it can be accessed over internet communication network through a firewall (40) using internet browser from a desktop, a communication means such as but not limited to laptop or from a mobile/hand held devices like a mobile phone, a Personal Digital Assistant (PDA), palm-top, mobile digital assistant, computer, laptop, notebook or personal computer, cell phone (50). Further user interface for the manpower planning and scheduling system may be preferably forms based.

In this centralized architecture, the ‘Application server’ (110) is preferably installed on a multi-core, high end CPU/processor server and hosts user interface module with control flows, integration module.

In this centralized architecture, the ‘Forecasting engine’ (120) is preferably installed on a multi-core, high end CPU/processor server, on which preferably no other applications are installed or no other tasks are performed while forecasting. This is due to the intense processing and data input/output being performed during generation of business forecasts.

In this centralized architecture, the ‘Scheduling engine’ (130) is preferably installed on a multi-core or a single core, high end CPU/processor server, with full RAM available to process the CPU intensive schedule generation and preferably no other applications are installed or no other tasks are performed while schedule generation. This is due to the intense processing and data input/output being performed during generation of workfare schedules.

In this centralized architecture, the ‘Database’ (140) with a large disk space is connected to the data warehouse through high capacity bus and the data is downloaded from the historical data database to the manpower planning and scheduling systems database through an ETL process (30).

Further, in one of the implementations, the system has a distributed architecture where some modules of the system are installed at central/corporate location (Corporate part) and other modules are installed at local business unit location (Distributed part).

In this distributed architecture, the modules such as ‘Forecast Business’ would be installed at central corporate location on a machine having specification similar to that of the ‘Forecasting engine’ described above.

In this distributed architecture, the modules such as ‘Configure and Download data’, ‘Estimate workload Hours’, ‘Budget compliance’, ‘Positioning fixed work’, ‘User interface’, ‘Data download to the distributed local machines over WAN/intranet’, ‘Updating data to external systems such as Time and Attendance’, would be installed at central corporate location on a machine having specification similar to that of the ‘Application Server’ described above.

In this distributed architecture, the modules such as ‘Scheduling Engine’, ‘User interface’ and “Data upload to the central/corporate local machine over WAN/intranet” may be installed on a local computer available at each unit in the organization and would installed on a machine having specification similar to that of the ‘Scheduling engine’ described above and would be used for workforce schedule generation, modification at each unit. Optionally, there may be database installed on each local machine either on the ‘Scheduling Engine’ or on a separate database server.

As apparent in this distributed architecture the Scheduling server may have other applications installed or can be used to perform other tasks and the ‘User interface’ and ‘Data download’ modules are similar to that of the centralized architecture. This distributed architecture ensures smooth bilateral decision/data flow between the corporate and its constituent units and minimizes Total Cost of Ownership and improves scalability.

Further, in another such implementation, the system may be hosted on a cloud computing environment where all the users access the system using the internet and such implementation would be very similar to centralized architecture and all the modules would be installed on cloud environment with the exception that optionally forecasting engine should be installed on the corporate network as data transfer between ‘Forecasting engine’ and ‘Data warehouse’ would be very voluminous.

Further, the manpower planning and scheduling system is scalable in terms of number of business units it can handle. In case number of business units in an organisation increases, then one may have to add additional servers/processers for the ‘Forecasting engine’ irrespective of the system architecture. In case of a centralized architecture additional servers/processors need to be added for the ‘Scheduling engine’ to make the system scalable. But a distributed architecture can handle as many business units as possible without further investment in hardware as the scheduling component would be installed on a local machine.

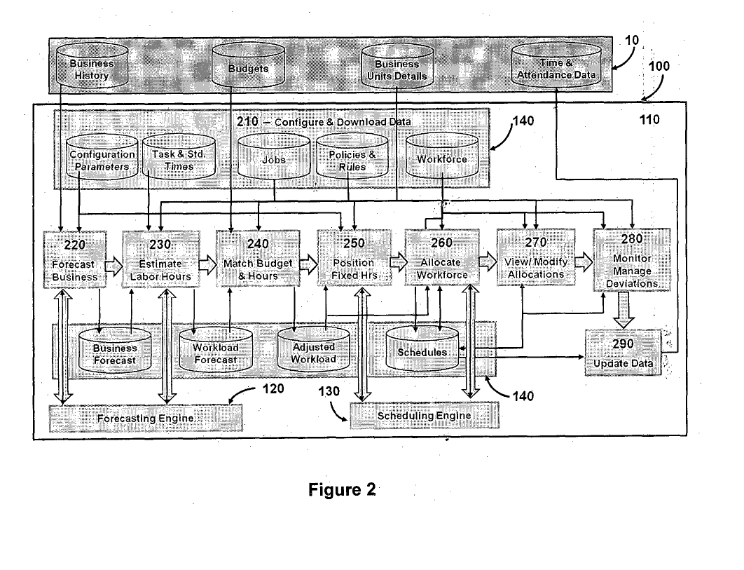

According to one of the embodiments of the present invention, FIG. 2 of the present invention illustrates the subsystems and information flows and transforms involved in manpower planning and scheduling; wherein the method comprises of the following steps:
210: Configuring various static parameters optional or mandatory, including but not limited to the relative importance of the different scheduling goals, planning interval time granularities (15/30/60/120 minutes), the parameters of the scheduling engine and downloading and configuring various other parameters such as the description of the unit where labour is being managed which includes location specific rules, size, hours of operations (24 hours, non 24 hours), jobs to be performed, engineering work standards applicable and the description and constraints on the available workforce; various job types, work rules applicable and optionally downloading some or all of these parameters from external systems
220: Forecasting business drivers/indicators and downloading business history from external system
230: Estimating manpower hours and costs
240: Ensuring consistency in manpower budgets and estimated labour costs
250: Optimally positioning home office work
260: Optimally allocating workforce subject to the combination of objectives and constraints and business rules
270: Viewing and modifying the allocations and reallocating breaks automatically post modifications
280: Monitoring deviations in forecasted schedule and managing allocations to meet the operation exigencies due to deviation from forecasted schedule
290: Updating planned/scheduled work into data bases, (may be external)

In a preferred embodiment of the present invention, in step 210, ‘Configure and Download data’, the system for manpower management provides a module for configuring/selecting various parameters, optional or mandatory, such as, but not limited to, planning horizon (number of plan days), planning time granularity (15/30/60/120 minutes), shift length granularity and minimum and maximum duration of shift length shift start time range and interval, allow splitting of a shift functionality, allow multiple jobs being scheduled in a shift, minimum length of same job in a shift, forecasting method to be applied, the relative importance of the different scheduling goals, the scheduling engine internal, is implemented in a module called the ‘Configure and Download Data module’. The module also includes downloading and configuring various other parameters such as the description of the unit where labour is being managed which includes location specific rules, size, hours of operations (24 hours, non 24 hours), jobs to be performed, engineering work standards applicable and the description and constraints on the available workforce; various job types, work rules applicable.

Further in step 220, ‘Forecast business’, the system for manpower management provides a method of forecasting business drivers/indicators comprising of a module for forecasting business drivers/indicators using one or more provisions is further provided with the following two provisions:
Option to select forecast granularity.
Option to select various manual or automated (best fit) forecasting techniques for forecasting manpower planning and scheduling for different normal days or for a combination of normal days or for a particular period.
Option to select various manual or automated (best fit) forecasting method for forecasting manpower planning and scheduling for special days or special weeks defined in terms of irregular, demand patterns.

The step is implemented in the ‘Forecasting engine’ (120).

Further, in step 230, ‘Estimate manpower hours’ the forecasted business drivers/indicators are converted into manpower hours (staffing needs) using a module for converting the business drivers/indicators forecasts into manpower hours. The effort required by the manpower in terms of hours for various different departments or jobs or tasks or roles is defined and further implemented in step 30 using the following:
Engineering time standards.
Rules to optimally use employees with multiple skills.
Rules such as daily and weekly minimum manpower staffing levels, minimum and maximum hours of work per day, per week.
The fixed work to be completed as per operational needs.

Further, in step 240, ‘Match budget and hours’, the forecasted manpower hours and cost are adjusted against the budgeted expenses, using a module for matching manpower budget hours and budget allocation. This step ensures the consistency and fairness between the manpower budget and the forecasted workload costs (staffing needs) and ensures that the allocated staffing needs (manpower hours and costs) are within the allocated manpower budgets.

The step is implemented on the ‘Forecasting engine’ (120).

Further in step 240, ‘Match, budget and hours’ brings consistency between the manpower budget and hours and costs are further estimated, adjusted and managed using mutual negotiations, if required.

Further, in step 250, ‘Positioning fixed work hours’, the distribution or positioning of fixed (home office) work to the respective jobs/roles/departments is done to smoothen out the overall staffing needs (manpower hours) and to further reduce manpower requirements using a module for positioning fixed work hours.

Further, in step 260, ‘Allocate workforce’, the system for manpower management optimally allocates the workforce (manpower) to provide manpower schedules by matching the staffing needs (manpower hours) considering various internal/corporate policies, external/federal/state/union regulations and considering the following key management drivers:
Workforce (manpower) utilization & cost
Fairness in allocation
Customer service & morale of manpower (employee or worker or staff)
Corporate, statutory and union work rules, workforce preferences

The step is implemented on the ‘Scheduling engine’ (130).

Further, in step 260, ‘Allocate workforce’, the system for manpower management generates a manpower plan and schedule by considering fairness in allocation of available work hours/labour (supply) to the planned requirements (demand) as follows:
a. Fairness between times of day & days of week, for each job-type to avoid bunching of deficit/understaffing and surplus/overstaffing at some specific time.
b. Fairness between job-types, over entire week, to avoid bunching of deficit/understaffing and surplus/overstaffing in some jobs.
c. Fairness between people, over entire week, to avoid bias.

Further, in step 260, ‘Allocate workforce’, the fairness criteria are implemented concurrently with the other objectives and constraints within a highly scalable and time efficient, iterative search algorithm to rapidly generate schedules.

Further, in step 260, ‘Allocate workforce’, the manpower plan and schedule is generated in a multi-stage, optimal, time efficient and scalable manner using in a highly scalable, time efficient, and iterative search and improvement algorithm.

Further, in step 260, ‘Allocate workforce’, the iterative search and improvement algorithm uses steps such as Add Shift, Delete Shift and Modify Shift to generate the better scheduler iteratively and ‘Allocate Breaks’ to assign appropriate breaks as per the business rules.

Further, in step 260, ‘Allocate workforce’, the system is scalable in terms of number of number of employees and jobs it can handle as it uses the iterative search algorithm.

In step 270 i.e. ‘View and Modify Allocations’, the system for manpower management provides a module for accommodating and facilitating adjustments or editing of the generated schedule via a highly interactive Gantt chart by the planners or users to improve implementability and manageability of the generated schedule. Subsequently the system provides a module for automatically reallocating the breaks to the shifts to meet the break rules, if needed. The view depicts the impact (e.g. cost or violation of constraints, business rule etc) of any changes made to the schedule so as to guide the user. Changes in the schedule can be retracted and saved when finality is achieved.

Further in step 280 i.e. ‘Monitor and manage deviations’, the system for manpower management provides a module to facilitate the monitoring of deviations from the planned schedule during day-to-day operation via an agile real time alert generation mechanism and managing allocation, to facilitate the adjustment of the manpower schedule manually or automatically (best fit) the day-of-operations exigencies to deviations from forecasted schedule.

Further, in step 290 i.e. ‘Update Data’, the system for manpower management provides a module to facilitate updating planned/scheduled work into various systems such as, but not limited to, Time & Attendance.

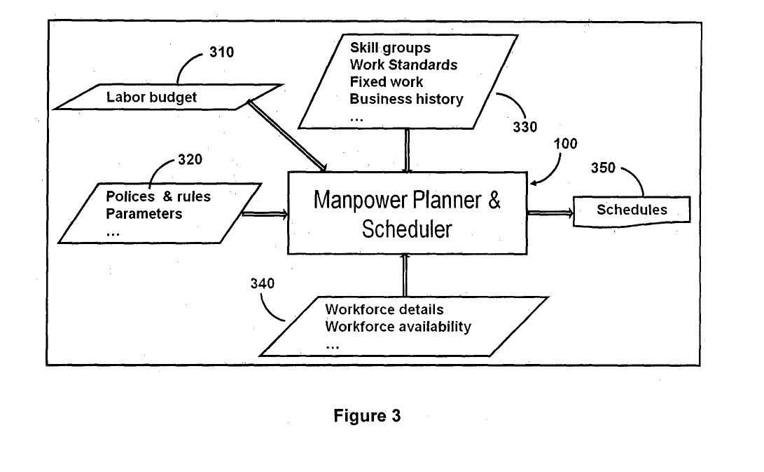

FIG. 3 of the present invention illustrates the system inputs and outputs for manpower planning and scheduling system.

According to one of the embodiments of the present invention, the manpower planning and scheduling system comprises of the following inputs provided to the manpower planner and scheduler (100) for planning and scheduling the manpower:
310: Labour budget
320: Parameters, Corporate policies, and Rules
330: Details about business driver/indicators, job types, skilled manpower groups, work standards, fixed work and business history
340: Workforce details and availability

The output from the manpower planning and scheduling system is a roster/schedule for the employees of a business unit (350).

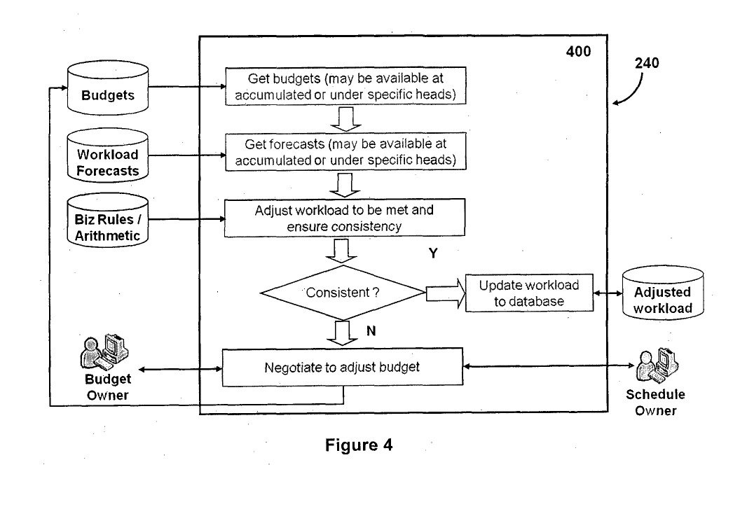

FIG. 4 of the present invention illustrates one optional sub-system and mechanism to ensure budgetary compliance for manpower costs incurred in the schedule carried out in step 240.

One of the embodiments of the present invention, the manpower planning and scheduling system comprises of the method and system for matching the cost of workload hours as per budget. This is described in FIG. 4. The method and system comprises: getting budget data and the forecasted workload data (generated in step 230), ensuring the consistency and fairness of the budget allocations and the costs of the forecasted workload hours by distributing the corporate budget to various levels such as jobs/sub unit of a unit or days of week using, but not limited to, business rules, arithmetic and parameters to match the distributed budgeted workload to the forecasted workload hours and discussions or negotiations between budget owners and scheduler owners. This is to ensure that the schedule or allocation plan generated does not violate the budget as per the business rules.

In one preferred case, if the aggregated budget expenses are available at the aggregated unit level only, then the forecasted workload cost is also aggregated at the unit level and then scaled up or down (adjusted) to bring it within the acceptable range/bands as specified in the business rules ensuring various constraints such as minimum staffing (daily/weekly/monthly) levels, fixed workload and minimum work hours for employees are complied with. In case the forecasted workload cost cannot be brought within the preferred band specified as a business rule, the same is escalated to budget owner for negotiations, for advice and possible budget corrections or exception approvals.

In another preferred case, if the budgeted expenses are available with breakups in a specified hierarchy e.g. at unit level, at sub unit level, at job type level, at day level then the forecasted workload cost is also aggregated to this levels and then scaled up or down (adjusted) to meet the range/bands as specified in the business rules, ensuring various constraints such as minimum staffing (daily/weekly/monthly) levels, fixed workload and minimum work hours for employees are complied with. In case the forecasted workload cost cannot be brought within the preferred band, the same the escalated to budget owner for negotiations and, for advice and possible budget corrections or exception approvals.

In another preferred case, rules may specify permissible bands at all/different level of hierarchy and the system and method would then ensure such consistency.

In another preferred case, the matching of budget figures and forecasted figures are done at each hierarchy level and user will follow the exception path of escalating to budget owner in case the adjusted forecast workload cost figures are not within the specified band.

In one of the embodiments of the manpower planning and scheduling system, the iterative search process is implemented to rapidly generate manpower schedules. The iterative process of improving/modifying the workforce schedule is used to obtain the best possible schedule. The process searches the set of feasible solutions while reducing the chance of getting stuck in poor local optima by allowing moves to inferior solution under the control of randomized scheme. First it generates an ‘initial’/‘current’ solution and then iteratively improves the same by modifying the ‘current’/‘incumbent’ solutions. The objective values of new solutions are compared with the current/incumbent solutions. New solutions, even if inferior to current/incumbent solutions are accepted with some probability to get out of local optima. Initially the value of control parameter is high and thus allows many inferior solutions to be accepted and is slowly reduced to a value where inferior solutions are nearly always rejected. This improves the global optimality of the solution.

As the manpower scheduling problem is NP-complete problem, it requires huge processing and this schedule generation is CPU bound and thus needs high end CPU and RAM available.

In another embodiment of the manpower planning and scheduling system, the process includes a mechanism to calculate the value of the control parameter and rate of reduction automatically and convergence/exit of the process automatically as the search for the optimal solution proceeds. The initial values of the control parameter and the rate of reduction are adjustable parameters.

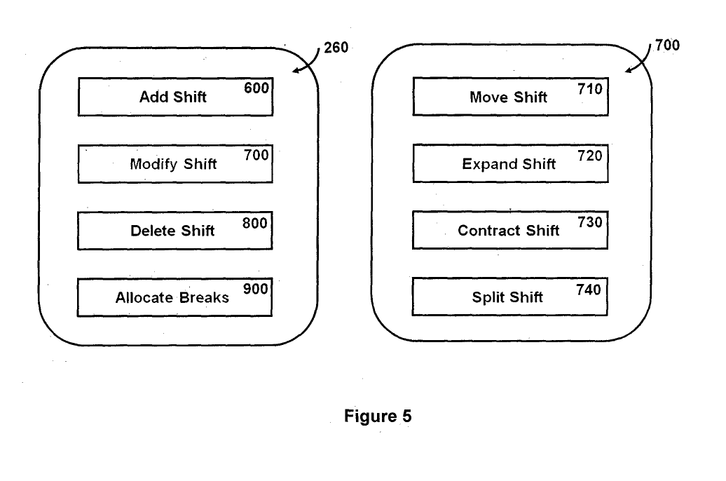

FIG. 5 of the present invention illustrates the sub-system and process/steps of generating and modifying schedule i.e. it represents a schematic diagram of the schedule generator.

In one of the embodiments of the manpower planning and scheduling system, the schedule generation process described in (260) uses:
Steps to add shifts or allocations to the schedule (600),
Steps to modify the shifts (700), further comprise but are not limited to, of sub-steps such as Move Shift (710), Expand Shift (720), Contract Shift (730), and Split Shift (740),
Steps to delete shifts (800) and
Steps to allocate breaks to shifts (900).

The steps generates feasible schedules and in one of the embodiment of the of the manpower planning and scheduling system the feasibility is checked using rules such as, but not limited to:
1) Employee's eligibility—Availability, prior allocation, skills to perform the job.
2) Mandatory (statutory) constraints—Daily/Weekly maximum and minimum hours of work, maximum work days in a week, maximum consecutive days of work, minor rules, break rules.
3) Corporate policies & union rules—Unit's operating hours, budget compliance, minimum staffing rules, union rules such as seniority rules, job priority.

Violating the rules mentioned above leads to infeasible schedules. Using the ‘Configure Configure and Download Data module’, user can select the constraints and rules to be used while scheduling as well as which of them are mandatory or desirable.

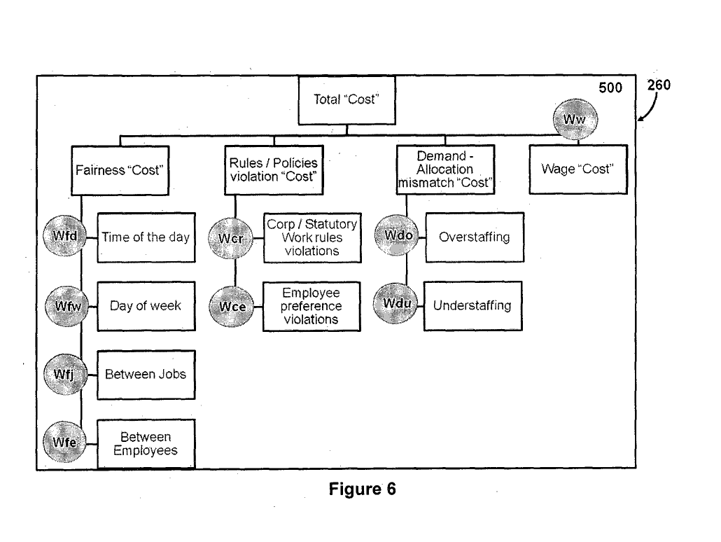

FIG. 6 of the present invention illustrates the system and method of calculating the objective function value for a schedule. It illustrates the fairness calculation mechanism and other costs used for manpower planning and scheduling by an embodiment. Pseudo costs represent monetary values attached to undesirable features of the schedule like not serving customers, unfairness in allocation and not meeting employee preferences.

The objective function is a weighted sum of costs and pseudo costs pertaining to fairness, constraint violations, demand-allocation mismatches and employee wage costs. Each of these costs have a weight/penalty factor associated with them that may be defined at lowest level of granularity i.e. they may differ for each job, for each associate, for each day, for time period in a day, if required. These parameters are set at installation time and may be adjusted (210).

The illustrative example of costs is given in the FIG. 6 but the possible costs are not limited to the ones given in FIG. 6.

The fairness cost is a weighted sum of following:
a. Between times of day & days of week, for each job-type to avoid bunching of deficit/understaffing and surplus/overstaffing at some specific time.
b. Between job-types, over entire week, to avoid bunching of deficit/understaffing and surplus/overstaffing in some jobs.
c. Between people, over entire week, to avoid bias.

In one of the embodiments of the manpower planning and scheduling system the fairness pseudo costs are measured as an example but not limited to, as the variation/spread of the respective criteria or as the function which preferably would be a non linear, second ordered polynomial, and magnifies the difference.

In one of the embodiments of the manpower planning and scheduling system, to speed up the search for optimality, only the changed schedule costs are re-calculated in each cycle.

A preferred implementation of the objective function in form of mathematical model is given below:

| | | | |
|---|---|---|---|
| a | Associates | a ∈{1 . . . NosAsso} | Total number of Associates |
| | | | to be scheduled |
| w | jobs | w ∈{1 . . . NosJobs} | Total number of Jobs to be |
| | | | scheduled |
| d | Day in a | d ∈{1 . . . NosDays} | Number of Days in the plan |
| | week | | |
| p | Time Period | p ∈{1 . . . NosPeriods} | Number of Time periods |
| | | | in a Day |

Workload|w,d,p as demand in number associates required at the day ‘d’, period ‘p’, for job ‘w’, BA|a,w,d,p a Boolean variable, 1 if associate ‘a’ is allocated to period ‘p’ on day ‘d’ on job ‘w’ else 0, AssoAlloc|w,d,p is number of associates allocated for job ‘w’ on day ‘d’, and period ‘p’, WeeklyAllocHrs|a—number hours allocated to associate ‘a’, in a week.

Wfw as penalty factor associated with spread/concentration of fairness elements such as surplus and deficit across days in a week, Wfd as penalty factor associated with spread/concentration of fairness elements such as surplus and deficit across periods in a day, Wfa as penalty factor associated with spread/concentration of allocation across associates, Wfj as penalty factor associated with spread of allocation across jobs.

### Objective Functions Elements:

### Fairness Across Day (Between Times of Day):

DailyFairnessCost=Wfd*(Σw,d{F(FairElementRatioDaily|w,d,p)}

FairElementRatioDaily|w,d,p={FairElement|w,d,p/Workload|w,d,p} If Workload|w,d,p>0 FairElementRatioDaily|w,d,p={0} Otherwise FairElement|w,d,p is fairness elements such as, but not limited to, overstaffing and understaffing. (03)

### Fairness Across Week (Between Days of Week):

WeeklyDefFairnessCost=Wfw*(Σw{F(FairElementRatioWeek|w,d)}

FairElementRatioWeek|w,d={FairElement|w,d/Workload|w,d} If Workload|w,d>0 FairElementRatioWeek|w,d={0}. Otherwise FairElement|w,d is fairness elements such as, but not limited to, overstaffing and understaffing. (04)

### Fairness Across Associates (Between Associates, Over Entire Week):

FairnessAcrossAssociateCost=Wfa*{F(WeeklyAllocRatio|a)}

WeeklyAllocRatio|a={WeeklyAllocHrs|a/WeeklyMaxHrs|a} (05)

### Fairness Across Jobs (Between Jobs, Over Entire Week):

FairnessAcrossJobsCost=Wfj*{F(JobAllocRatio|w)}

JobAllocRatio|w={Σd,p{AssoAlloc|w,d,p}/Σd,p{Workload|w,d,p}} If Σd,p{Workload|w,d,p}>0 JobAllocRatio|w={1} Otherwise (06)

### Objective Function:

Minimize Z=Wage Cost+Under Staffing Cost+Over Staffing Cost+Constraint Violation Cost+Employee Preference Violation Cost+DailyFairnessCost+WeeklyFairnessCost+FairnessAcrossAssociateCost+FaimessAcrossJobsCost (07)

In one of the embodiments of the manpower planning and scheduling system, the function F preferably would be a non linear, second ordered polynomial which magnifies the difference.

### ADVANTAGES OF THE INVENTION

a. The invention provides a system and method for effective and complete manpower management and scheduling in, primarily, service industries.
b. Provides for hardware and network support in a plurality of efficient architecture and configuration options
c. Provides for the development of manpower schedules whose costs and their distributions are compliant to the budgetary labour expense plans while being driven by requirement forecasts from historical business.
d. Provides a system and method for generating manpower plans and schedules that meet a set of “fairness” criteria, including but not limited to, fairness across employees, types of work, hours of each day and days of week when distributing the desirable or undesirable features of the plan.
e. Provides a scalable and time efficient system and method for the development of manpower schedules that optimize customer service, labour costs and employee morale and thus increase the value of the schedules while meeting user-defined sets of statutory, corporate or union rules or constraints thereby ensuring that the schedules are legally and otherwise fit for implementation.
f. Provides a system and a method for the easy and effective manual modification and changes to the schedules to improve their implementability and value.
g. Provides a system and method for optimally positioning home office staffing needs to minimize labour requirements.

1. A method for providing a scalable, time efficient, budget compliant manpower plan and schedule using a manpower management system, wherein the said method comprises the following computer implemented steps that are executed iteratively in parallel on multiple machines:
a. forecasting business drivers or indicators using the forecasting engine (120)
b. matching budget and hours (240) for building consistency and fairness between manpower budget allocations and costs of manpower hour estimations; wherein the said costs and distributed manpower hours are made compliant to the budgetary manpower allocation and expense plans
c. positioning fixed work hours (250) to the respective jobs or roles or departments for smoothening out the overall staffing needs manpower hours and to further reduce manpower requirements using a module for positioning fixed work hours
d. scheduling using the scheduling engine (130) for optimally allocating the available manpower and generating fair manpower plans and schedules and allocating breaks for each shift; wherein the said manpower plans and schedules are generated on the basis of one or more “fairness” criterion by considering one or more dimensions, wherein the said “fairness” criterion is a weighted sum of following:
i. between times of day and days of week, to avoid bunching of deficit or understaffing and surplus or overstaffing at some specific time;
ii. between job-types, over entire week, to avoid bunching of deficit or understaffing and surplus or overstaffing in some jobs; and
iii. between people, over entire week, to avoid bias.

2. The method of claim 1, further comprising the computer implemented steps of:
a. downloading and configuring the parameters of the manpower management system and further downloading and integrating static and dynamic organizational data, budget and manpower data from one or more external systems integrated to the manpower management system through one or more computer networks;
b. extracting, transforming and loading business history and forecasting future business volumes on a database of the manpower management system by the data ware house system using the Extract, Transform and Load processor (ETL processor);
c. converting the forecasted business volumes of step (a) into manpower hours;
d. distributing or positioning the fixed work hours optimally;
e. viewing and optionally modifying or adjusting the generated manpower plan and schedule;
f. transferring the planned and scheduled allocations into data bases including, but not limited to, that for time and attendance.

3. (canceled)

4. (canceled)

5. (canceled)

6. The method of claim 2, wherein the said parameters required for manpower management are stored in a database, wherein the said parameter can be dynamic or static parameters, which further comprises of relative importance of the different scheduling goals, planning interval time granularities, scheduling engine parameters, description of the manpower unit parameters where manpower is being managed, description and constraints of the available manpower; various job types or applicable work rules.

7. (canceled)

8. The method of claim 1, wherein the manpower hours can be calculated by using a) engineering time standards and b) rules comprising daily and weekly minimum staffing levels.

9. The method of claim 1, wherein the allocation of manpower for allocating and deploying, matching the manpower hours considers but is not limited to the following criteria such as fairness, internal policies, corporate policies, external, federal, state or union regulations; workload generation; minimum wages; minimum and maximum working hours, break rules or combination thereof.

10. The method of claim 2, wherein the modification or adjustment of the manpower allocation to meet the day of operations exigencies is done manually using interactive Gantt charts; further the reallocation of the breaks is done automatically to avoid violation of any break rule.

11. The method of claim 1, wherein the said dimensions comprises of fairness in allocation of available work hours between times of day & days of week, between job-types, between people.

12. (canceled)

13. (canceled)

14. (canceled)

15. A manpower management system for providing a scalable, time efficient, budget compliant manpower plan and schedule, wherein the said system comprises of:
a. manpower planning and scheduling core application server;
b. one or more databases stored on a computer readable medium;
c. forecasting engine and scheduling engine;
d. one or more external systems integrated with the manpower management system through one or more computer network;
e. communication means with a user interface associated with manpower management system;
f. module for building consistency and fairness between the manpower budget allocations and the costs of the manpower hour estimations; wherein the costs and distributed manpower hours are made compliant to the budgetary manpower allocation and expense plans;
g. module for allocating the available manpower and generating fair manpower plans and schedules and allocating breaks for each shift; wherein the said manpower plans and schedules are generated on the basis of one or more “fairness” criterion by considering one or more dimensions.

16. The system of claim 15, wherein the user interface for the manpower planning and scheduling system consists of a web based interface which can be accessed over a communication network through a firewall from communication means.

17. A system of claim 15, wherein the said manpower planning and scheduling core application server hosts the principal components of the manpower management system, which primarily comprises of components such as modules and subsystems for user interface comprising control flow; integration module to connect with one or more external systems.

18. A system of claim 15, wherein the said ‘Forecasting engine’ and ‘Scheduling engine’ consists of analytical modules including as forecasting module, workload generator module and scheduling module.

19. A system of claim 15, wherein the said database stores the data for static and dynamic parameters required for manpower management.

20. A system of claim 19, wherein the said static and dynamic parameters comprises of relative importance of the different scheduling goals, planning interval time granularities, scheduling engine parameters, description of the manpower unit parameters where manpower is being managed, description and constraints of the available manpower; various job types or applicable work rules.

21. A system of claim 15, wherein the said one or more databases are connected to data warehouse of external system for downloading business history data and forecasted future business volume data for manpower planning and scheduling using a Extract, Transform and Load (ETL) processor.

22. A system of claim 15, wherein the said manpower management system is integrated with a ‘Data Warehouse system’, a ‘Budgeting system’, a ‘Corporate Units database system’, a ‘Time and Attendance system’, and a ‘Human Resource system’ of the said external system to fetch and download data such as historical business volume data, budget data, business unit details, punched data or actual schedule execution data, and manpower details respectively through a computer network.

23. A system of claim 15, wherein the said forecasting engine forecasts the business volumes or indicators using one or more provisions, wherein the provision consists of a) an option to select either manual or automated forecasting techniques for different days, combination of days, or particular time period; and b) option to select either manual or automated forecasting method for special days, weeks defined in terms of irregular demand patterns.

24. A system of claim 15, wherein the manpower management system further comprises of the following computer implemented software modules:
module for downloading and configuring the parameters of the manpower management system and further downloading and integrating static and dynamic organizational data, budget and manpower data on the said ‘Forecasting engine’ and ‘Scheduling engine’ of the said manpower management system from the external system integrated to the manpower management system;
module for extracting, transforming and loading business history and forecasting future business volumes on a database of the manpower management system by the data ware house system using the Extract, Transform and Load processor (ETL processor);
module for converting the forecasted business volumes into manpower hours;
module for distributing or positioning the fixed work optimally;
module for viewing and optionally modifying or adjusting the generated manpower plan and schedule;
module for transferring the planned and scheduled allocations into data bases including, but not limited to, that for Time and Attendance.

25. (canceled)

26. (canceled)

27. (canceled)

28. (canceled)

29. (canceled)

30. A system of claim 24, wherein the said modules can be distributed and implemented on one or more computer networks in a plurality of possible architectures and configurations; wherein the said architectures and configurations comprises of centralized, distributed or cloud computing environment.

31. A system of claim 8, wherein the said ‘Scheduling engine’ is implemented on a multi-core, high end Central processing unit (CPU) or processor computing server or machine, which in turn implements an iterative search process to generate schedule and that the iterative search uses parallel computing, by generating multiple intermediate trial schedules, one intermediate schedule on each core, by executing scheduling steps 600, 700, 800, 900 and compute of the change in schedule “cost” and then selecting the best intermediate schedule among these multiple intermediate schedules as next best schedule and repeating these steps for many iteration to get the final schedule, the said iterative search process also uses a fairness quotient such that generated schedules are employee friendly and easier to implement, the said fairness quotient is a weighted sum of following:
a. Between times of day and days of week, for each job-type to avoid bunching of deficit or understaffing and surplus or overstaffing at some specific time;
b. Between job-types, over entire week, to avoid bunching of deficit or understaffing and surplus or overstaffing in some jobs; and
c. Between people, over entire week, to avoid bias.

32. A system of claim 8, wherein the said ‘Forecasting engine is implemented on a multi-core, high end central processor unit (CPU) or processor computing server or machine, and the method of forecasting business drivers or indicators uses parallel computing, where the forecast for multiple sites or forecast for different business drivers of a site, are generated simultaneously, by generating the forecast for a site on each core or forecast for different business drivers of a site on each core as configured or decided by the load balancing.

33. A system of claim 15, wherein the communication means comprises of mobile phone, a personal digital assistant (PDA), palm-top, mobile digital assistant, computer, laptop, notebook or personal computer.
